(19) United States
(12) Patent Application Publication
(10) Pub. No.: US 2014/0280098 A1
(43) Pub. Date: Sep. 18, 2014

(54) PERFORMING APPLICATION SEARCH BASED ON APPLICATION GAMINESS

(71) Applicant: Quixey, Inc., Mountain View, CA (US)

(72) Inventors: Eric Glover, Palo Alto, CA (US); Abdelhalim Abbas, San Jose, CA (US)

(73) Assignee: Quixey, Inc., Mountain View, CA (US)

(21) Appl. No.: 14/216,054

(22) Filed: Mar. 17, 2014

Related U.S. Application Data
(60) Provisional application No. 61/790,215, filed on Mar. 15, 2013.

(51) Int. Cl. G06F 17/30

(52) U.S. Cl. CPC G06F 17/30867; G06F 17/3053
USPC 707/723

(57) ABSTRACT

An application search system compensates for game bias in search results using a gaminess value representing the likelihood that an application is a game. The application search system receives a gaminess value for an application from an external source, such as an operator, or automatically determines the gaminess value using a trained computer model. The computer model may be trained based on a supervised training set of data. The gaminess value of an application is used to determine relevance of applications responsive to a search query. In one configuration, the gaminess value is incorporated as a scoring feature by the application search system in a computer-learned relevance search. The gaminess value may be used as a relevance factor even when the search does not indicate a user's desire to search for a game.

### CROSS-REFERENCE TO RELATED APPLICATION

This application claims the benefit of U.S. Provisional Application No. 61/790,215 filed Mar. 15, 2013, which is hereby incorporated by reference in its entirety.

### BACKGROUND

In application search systems, data such as application download rates and popularity are used as inputs for facilitating searches. One problem with using such data is that game type applications (also referred to herein as “games”) generally have substantially higher promotion rates, are associated with higher download rates, and are more popular overall. Thus, games are typically over-represented in the data used for facilitating application search. As a consequence, search results generated by current application search systems frequently are biased towards games, even for terms that do not relate to games. Specifically, games are often too highly ranked within generated search results. For example, a search for “find cafe” on a popular application search yields results that relate to cafe-related games, rather than results relating to finding a cafe. Though an application for locating cafes is listed in the search results, the results in this example are heavily biased towards games and obscure a more relevant café locator application.

### BRIEF DESCRIPTION OF DRAWINGS

FIG. 1 is a high-level block diagram of a computing environment for performing application search according to one embodiment.

FIG. 2 shows components of a search system according to one embodiment.

FIG. 3 illustrates the components of an application record according to one example embodiment.

FIG. 4 shows an example of a flow for generating a gaminess value using a gaminess computer model.

FIG. 5 shows an example search module which may be included in the search system.

FIG. 6 shows an example method for performing a search based on a received search query.

FIG. 7 is a block diagram illustrating components of an example machine able to read instructions from a machine-readable medium and execute them in a processor (or controller).

### DETAILED DESCRIPTION

The figures and the following description relate to example implementations by way of illustration only. It should be noted that from the following discussion, alternative implementations of the structures and methods disclosed herein will be readily recognized as viable alternatives that may be employed without departing from the scope of the disclosure.

The present disclosure relates to searches for software applications (i.e., “applications”). In one embodiment, an application search system compensates for game bias in order to improve the relevancy of search results. As used herein, the relevancy of a search result relates to how closely the search result aligns with the intent of and/or context associated with a particular search query for which the search result was generated.

A search system receives a search query from a user's computing device (e.g., a mobile computing device). The search system generates search results in response to the received search query. The search results may include a list of applications and result scores associated with the applications. The result scores may be used to rank the applications in the list. For example, a larger result score associated with an application may indicate that the application is more relevant to the received search query. The search system may transmit the search results to the user's computing device so that the user may select one of the applications to preview and/or download.

The search system includes an application data store which the search system may use to generate the search results. The application data store includes data associated with a plurality of different applications. The data associated with an application may be referred to herein as an “application record” (e.g., an application record 270 of FIG. 3). The application data store may include a plurality of different application records that each includes data related to a different application. In some implementations, the application data store may not store the applications (e.g., the executable programs) described by the application records. Instead, the applications may be accessed on one or more application marketplaces that are configured to distribute the applications.

An application record may include a variety of different types of data related to an application. In some implementations, an application record may include the name of the application, the developer of the application, a description of the application, and a category of the application, along with other data described herein. An application record also includes an indicator of the “gaminess” of an application, termed a gaminess value. The gaminess of an application corresponds to a likelihood or probability that an application is a game or has game-like functionality when executed. For example, an application may have a higher likelihood of being a game if the application is associated with certain scoring rules, levels or stages, and/or other game-like objectives.

An application's gaminess is determined by identifying a gaminess value for the application. The gaminess value may be determined by various methods. In one method, the application search system trains a gaminess computer model to determine a gaminess value. The gaminess model may be any suitable computer modeling or machine learning system, such as a Bayesian classifier.

Once the gaminess value is determined, the application search system minimizes or otherwise accounts for) game bias in search results using the determined gaminess value of the applications. As a result, the relevance of search results generated by the application search system may be substantially improved. For example, the search results generated by the application search system may include information that is closer or better aligned with the intent of the search query processed by the application search system.

To identify relevant search results to a query, the application search system analyzes the query and identifies a consideration set of applications. Next, the consideration set of applications are evaluated to generate a result score for each application the consideration set, and the consideration set is ranked based on the result scores. In this process, the gaminess value may be used to reduce game bias in several ways. In one configuration, the gaminess value is used to include or exclude applications from the consideration set of applications. In one configuration, the gaminess value is a scoring feature in determining the result score for an application. In this configuration the gaminess value may be included in a set of factors used to train a model that determines the result score for an application. In one configuration, the result score for an application is adjusted using the gaminess value. Each of these configurations and methods may be used independently or in any combination with one another.

As a result, the search system generates search results that reduce the bias towards game applications present in other searching techniques.

FIG. 1 is a functional block diagram illustrating an example environment including a search system 100 configured to perform searches for software applications. A software application may refer to computer software that causes a computing device to perform a task. In some examples, a software application may be referred to as an “application,” an “app,” or a “program.” Example applications include, but are not limited to, word processing applications, spreadsheet applications, messaging applications, media streaming applications, social networking applications, and games.

Applications can be executed on a variety of different computing devices. For example, applications can be executed on mobile computing devices such as smart phones, tablets, and wearable computing devices (e.g., headsets and/or watches). Applications can also be executed on other types of computing devices having other form factors such as laptop computers, desktop computers, or other consumer electronic devices. In some examples, applications may be installed on a computing device prior to a user purchasing the computing device. In other examples, the user may download and install applications on the computing device.

The functionality of an application may be accessed on the computing device on which the application is installed. Additionally, or alternatively, the functionality of an application may be accessed via a remote computing device. In some examples, all of an application's functionality may be included on the computing device on which the application is installed. These applications may function without communication with other computing devices (e.g., via the Internet). In other examples, an application installed on a computing device may access information from other remote computing devices during operation. For example, a weather application installed on a computing device may access the latest weather information via the Internet and display the accessed weather information to the user through the installed weather application. In still other examples, an application (e.g., a web based application) may be partially executed by the user's computing device and partially executed by a remote computing device. For example, a web application may be an application that is executed, at least in part, by a web server and accessed by a web browser of the user's computing device. Example web applications may include, but are not limited to, web-based email, online auctions, and online retail sites.

The search system 100 is configured to receive search queries from one or more user device(s) 102 via a network 104. The search system 100 performs a search for applications in response to a received search query. The search system 100 may generate a set of search results that includes a list of applications, each of which is associated with a result score that indicates the rank of the application relative to the other applications in the list. A list may comprise any listing, set, or grouping of applications, which may be ordered or ranked, and may include various data relating to the applications, such as the name, publisher, and other aspects of the application, and so forth. The result list may not include the application executable code, but may include a reference to a location where the executable code can be obtained. The search system 100 may then transmit the search results to the user device 102 that transmitted the search query.

A user device 102 may display the search results to the user and allow the user to select one of the applications in the list in order to view information related to the application and/or download the application. The applications (e.g., the executable programs) listed in the search results sent to the user device 102 may be accessible from (e.g., downloaded from) systems different than the search system 100 in some examples. Put another way, the search system 100 may store data related to applications that are accessible in locations other than the search system 100. For example, the applications may be accessible from a software application marketplace 106 (hereinafter “application marketplace 106”). The application marketplace 106 may be a digital distribution platform configured to distribute the applications. Example application marketplaces include, but are not limited to, Google Play developed by Google Inc., the App Store developed by Apple Inc., and Windows Phone Store developed by Microsoft Corporation. Although a single application marketplace 106 is illustrated in FIG. 1, the techniques of the present disclosure may be applicable to environments including multiple application marketplaces, as described herein. Although the applications listed in the search results generated by the search system 100 may be accessed in locations other than the search system 100, in some implementations the search system 100 includes applications for download.

The search system 100 includes various modules as described below for retrieving and indexing information relating to applications, generating a score indicating the likelihood an application is a game (“gaminess value”), and providing applications in response to a search query. The operation of various components in the search system 100 is described in further detail with respect to FIG. 2. In one embodiment, the application search system determines a gaminess value for each maintained application. In one aspect, the gaminess value for a particular application is selected from a range of values (e.g., a range between 0 and 1), where the range includes at least three different values. Each value may indicate a different degree of gaminess for an application. For example, the gaminess value for a particular application may be selected from 1,000 possible values between a range of 0 and 1, where a value of 0 indicates that an application is likely not a game and a value of 1 indicates that the application is likely to be a game. Thus, the 1,000 possible values may indicate varying likelihoods that an application is a game. Any suitable range of variables may be used for the gaminess values that permits distinguishing between applications for the purposes described herein.

The search system 100 may communicate with the user devices 102, a partner computing system 116, the application marketplace 106, and the data sources 114 via the network 104. Examples of the user devices 102, the partner computing system 116, the data sources 114, the application marketplace 106, and the network 104 are now described in turn.

The example environment illustrated in FIG. 1 includes a plurality of user devices 102. An individual user device may also be referred to herein as a user device 102. User devices 102 can be any computing devices that are capable of providing search queries to the search system 100. User devices 102 may include, but are not limited to, smart phones, tablet computers, laptop computers, and desktop computers, as illustrated in FIG. 1. User devices 102 may also include other computing devices having other form factors, such as computing devices included in vehicles, gaming devices, televisions, or other appliances (e.g., networked home automation devices).

The user devices 102 may use a variety of different operating systems. In an example where a user device 102 is a mobile device, the user device 102 may run an operating system including, but not limited to, ANDROID, iOS developed by Apple Inc., or WINDOWS PHONE developed by Microsoft Corporation. In an example where a user device 102 is a laptop or desktop device, the user device 102 may run an operating system including, but not limited to, MICROSOFT WINDOWS, MAC OS, or Linux (e.g., RED HAT LINUX). User devices 102 may also access the search system 100 white running operating systems other than those operating systems described above, whether presently available or developed in the future.

User devices 102 can communicate with the search system 100 via the network 104. In some examples, a user device 102 may communicate with the search system 100 using an application installed on the user device 102. In general, a user device 102 may communicate with the search system 100 using any application that can transmit search queries to the search system 100. In some examples, a user device 102 may run an application that is dedicated to interfacing with the search system 100, such as an application dedicated to application searches. In some examples, a user device 102 may communicate with the search system 100 using a more general application, such as a web-browser application. The application run by a user device 102 to communicate with the search system 100 may display a search field on a graphical user interface (GUI) in which the user may enter search queries. The user may enter a search query using a touch screen or physical keyboard, a speech-to-text program, or another form of user input.

A search query entered into a GUI on a user device 102 may include words, numbers, and/or symbols. In general, a search query may be a request for information retrieval (e.g., search results) from the search system 100. For example, a search query may be directed to retrieving a list of applications in examples where the search system 100 is configured to generate a list of applications as search results. A search query directed to retrieving a list of applications may indicate a user's desire to retrieve applications that have a functionality described by the search query.

A user device 102 may receive a set of search results from the search system 100 that are responsive to the search query transmitted to the search system 100. The user device 102 may be running an application including a GUI that displays the search results received from the search system 100. For example, the application used to transmit the search query to the search system 100 may also display the received search results to the user. As described above, the application that displays the received search results to the user may be dedicated to interfacing with the search system 100 in some examples. In other examples, the application may be a more general application, such as a web-browser application.

The GUI of the application running on the user device 102 may display the search results to the user in a variety of different ways, depending on what information is transmitted to the user device 102. In examples where the search results include a list of ranked applications, the search system 100 may transmit the list of applications to the user device 102. In this example, the GUI may display the search results to the user as a list of application names. In some examples, the search system 100, or other computing system, may transmit additional information to the user device 102 including, but not limited to, application ratings, application download numbers, application screenshots, and application descriptions. This additional information may be stored in the application data store 108 and transmitted by the search system 100 to the user device 102 in some examples. In examples where the user device 102 receives this additional information, the GUI may display this information along with the list of application names. In some examples, the GUI may display the search results as a list of applications ordered from the top of the screen to the bottom of the screen by descending result score. In some examples, the search results may be displayed under the search field in which the user entered the search query.

In some examples, user devices 102 may communicate with the search system 100 via the partner computing system 116. The partner computing system 116 may represent a computing system of a third party that may leverage the search functionality of the search system 100. The partner computing system 116 may belong to a company or organization other than that which operates the search system 100. Example third parties that may leverage the functionality of the search system 100 may include, but are not limited to, internet search providers and wireless communications service providers. The user devices 102 may send search queries to the search system 100 via the partner computing system 116. The user devices 102 may also receive search results from the search system 100 via the partner computing system 116. The partner computing system 116 may provide a user interface to the user devices 102 in some examples and/or modify the search experience provided on the user devices 102.

FIG. 1 shows a plurality of data sources 114A, 114B, 114C, 114D (collectively “data sources 114”). The data sources 114 are sources of data that the search system 100 uses to generate and update data relating to applications. For example, the search system 100 may generate new application records (e.g., application record 270 of FIG. 3) and update existing application records based on data retrieved from the data sources 114. As described hereinafter, the search system includes a module for generating a gaminess value for an application based on data retrieved from data sources 114.

The data sources 114 may include a variety of different data providers. The data sources 114 may include data from application developers 114A, such as application developers' websites. The data sources 114 may also include other websites, such as websites that include web logs 114B (i.e., blogs), application review websites 114C, or other websites including data related to applications. Additionally, the data sources 114 may include social networking sites 114C, such as Facebook (e.g., Facebook posts) and Twitter (e.g., text from tweets). Data sources 114 may also include additional types of data sources in addition to data sources 114A, 114B, 114C, 114D described above. Different data sources may have their own content and update rate.

FIG. 1 shows an application marketplace 106. The application marketplace 106 may be another source of data that the search system 100 uses to generate and update the application data store 108. For example, the search system 100 may generate new application records and update existing application records based on data retrieved from the application marketplace 106. Although only one application marketplace 106 is illustrated FIG. 1, the search system 100 may generate new application records and update existing application records based on data retrieved from multiple application marketplaces. Different application marketplaces may have their own content and update rate.

As described above, the use devices 102, the search system 100, the application marketplace 106, and the data sources 114 may be in communication with one another via the network 104. The network 104 may include various types of networks, such as a wide area network (WAN) and/or the Internet. Although the network 104 may represent a long range network (e.g., Internet or WAN), in some implementations, the network 104 may include a shorter range network, such as a local area network (LAN). The network 104 is any suitable system for connecting communications between these various systems, and may use any standard or non-standard communication technologies and/or protocols.

FIG. 2 shows components of a search system 100 according to one embodiment. The search system 100 includes various modules and components for performing application searches as described herein. The search system 100 stores data relating to applications in an application data store 260, which identifies data relating to individual applications in an application record 270, which is further described in FIG. 3. The search system includes a data intake module 210 for retrieving information relating to applications and populating the application data store 260. The search system also includes a search module 200 for performing application searches. A gaminess computer model 250 is a computer model for determining a gaminess value for an application. The gaminess computer model 250 is trained using a training selection module 220 and a training module 230. Gaminess module 240 applies the gaminess computer model 250 to generate gaminess values for individual applications. Each of these components is now further described.

Though shown here as a single system, search system 100 may be implemented as a group of separate systems that together perform the functions described herein. In addition, search system 100 may include more or fewer modules than those described herein in order to perform applications searches incorporating a measure of the gaminess of an application. For example, in a configuration wherein the search system 100 receives gaminess values from another system, the search system 100 may omit components that determine a gaminess value, such as the gaminess module 240 and gaminess computer model 250.

The data intake module 210 retrieves data from the application marketplace 106 and one or more of the data sources 114. The data retrieved from the application marketplace 106 and various data sources 114 can include any type of data related to applications. Examples of data related to applications include, but are not limited to, a name of an application, a description of an application, a substantive review of an application, a quality rating of an application, a developer name, an excerpt from a blog post about an application, a tweet about an application, and one or more images (e.g., icons and/or screenshots) associated with the application. In some configurations, data retrieved from the application marketplace 106 and data sources 114 includes information regarding the functionalities of applications. The data intake module 210 may also retrieve statistical data related to applications. Statistical data may include any numerical data related to the application, such as a number of downloads, download rates (e.g., downloads per month), a number of reviews, a number of ratings, and average rating score.

The application data store 260 includes a variety of different types of data related to different applications. The application data store 260 may include one or more databases, indices (e.g., inverted indices), files, or other data structures which may be used to implement the techniques of the present disclosure. As described herein, the data included in the application data store 260 may include descriptions of applications, application scoring features, a gaminess value, and other information. The search system 100 is configured to generate and update the data in the application data store 108 based on the data retrieved from the application marketplace 106 and data sources 114. For example, the search system 100 may use the retrieved data to update one or more databases, indices, files, or other data structures included in the application data store 108. As described herein, the application data store 108 may include a plurality of application records 270. The search system 100 may generate new application records and update existing application records 270 based on the data retrieved from the application marketplace 106 and data sources 114. In some examples, some data included in the application data store 270 may be manually generated.

FIG. 3 illustrates the components of an application record according to one example embodiment. FIG. 3 shows example data which may be stored the application data store 260. The application record 270 may generally represent data stored in the application data store 260 that is related to an application. The application data store 260 may include data related to a plurality of applications. The search system 100 (e.g., the data intake module 210 and gaminess module 240) may generate the data included in the application data store 250.

The example application record 270 includes an application name 300, an application identifier 302 (hereinafter “application ID 128”), application attributes 304, application scoring features 306, and a gaminess value 308. The application data store 260 may include a plurality of application records having a similar structure as the application record 120. The application name 300 is the name of the application represented by the data in the application record 120. Example application names include “Google Maps,” “Facebook,” “Twitter,” “Microsoft Word”, or “Angry Birds Space” The application ID 302 identifies the application record 270 among the other application cords 270 included in the application data store 260. For example, the application ID 302 may uniquely identify the application record 120. The application ID 302 may be a string of alphabetic, numeric, and/or symbolic characters (e.g., punctuation marks) that uniquely identifies the application record 270.

The application attributes 304 may include a variety of different types of data associated with the application represented by the application record 120. For example, the application attributes 130 may include structured, semi-structured, and/or unstructured data. The application attributes 130 may include information that is extracted or inferred from the application marketplace 106 and/or from the data sources 114. In some examples, the application attributes 130 may include data that is manually generated. The application attributes 130 may be updated by the data intake module 210 so that up to date results can be provided in response to a user search query.

The application attributes 304 may include the name of the developer of the application, the publisher of the application, a category of the application (e.g., communications), a description of the application (e.g., a developer's textual description), a version of the application, the operating system for the application, and the price of the application. The application attributes 304 may also indicate security or privacy data about the application, battery usage of the application, and bandwidth usage of the application. The application attributes 304 may also include information retrieved from websites such as reviews associated with the application, articles associated with the application (e.g., wiki articles), or other information. The application attributes 304 may also include digital media related to the application, such as images (e.g., icons and/or screenshots).

The application record 270 may include application scoring features 306. The application scoring features 306 may include any of the application attributes included in the application record or any additional parameters related to the application, such as data indicating the popularity of an application (e.g., number of downloads) and the ratings (e.g., number of stars) associated with an application. The search module 200 may use the application scoring features 306 to generate result scores for the application associated with the application record 120. As described herein, the gaminess module 240 may generate some of the application scoring features 306, specifically the gaminess value 308. In some implementations, application scoring features 306 may not be stored in the application data store 260. Instead, application scoring features 306 may be generated when a search request is received by the search system 100.

Referring back to FIG. 2, training selection module 220 and training module 230 are responsible for training a gaminess computer model 250. To identify the gaminess value 308 of a particular application, the search system 100 employs a gaminess computer model 250, which is a gaminess classifier that outputs a value representing the likelihood that an application is a game. The gaminess classifier may be any suitable type of classifier, such as a Naïve Bayesian type classifier, support vector machine, or similar.

The training selection module 220 selects a training set of applications and associated training data for training of the gaminess computer model 250. Each application in the training set is associate with a target gaminess value. The target gaminess value is the gaminess value used to train the output of the gaminess computer model 250 and indicates the desired or expected gaminess output value if that application's data is input to the gaminess computer model 250. The training set of applications in one embodiment includes at least one application designated as a game (e.g., designated by a human as a game) and at least one application that is designated as not a game. The training set of applications may comprise a negative and a positive training set. The negative raining set may correspond to desired gaminess values of “0” (not a game) and the positive training set may correspond to desired gaminess outcomes of “1” (a game). In another embodiment, the training set of applications is not associated with specific negative or positive training sets, but rather a target value in a range of gaminess values. For example, the training set may also include target gaminess values such as “0.2” (probably not a game), “0.5” (no prediction between game or not a game), or “0.8” (probably a game).

The training set and associated target training values for the gaminess may be generated by the training selection module in a variety of ways, which may be used alone or in any combination. In one embodiment, the training selection module 220 receives a designation of training applications and training gaminess values from a human operator of the search system 100. In this embodiment, the human operator of the search system indicates a set of applications that are games and a set of applications that are not games. In embodiments where the application may be designated a target gaminess value in a range (e.g., 0.2), the operator of the search system 100 may be provided options to categorize an application, such as “not a game” “probably not a game” “I can't tell” “probably a game” and “a game” which are mapped to target gaminess values. In another configuration, the target gaminess value is determined by crowd sourcing the categorization among many users. For example, an application may be presented to many users with a query of whether the application is a game. The training selection module 220 uses the responses of many users with respect to an application to determine a target gaminess value indicating the likelihood that the application is a game. For example, if nine out of ten responses indicate the application is a game, the application may be associated with a 0.9 target gaminess value.

In one configuration, the target gaminess values in the training set are determined by the training selection module 220 by analyzing the application data itself. For example, a dictionary of terms associated with games to identify application records with data associated with terms in the dictionary. For example the dictionary of terms may include “game” “level” “experience” “play” “player” “shooter” and so forth. Applications with application data matching some or all of the terms may be selected in a positive training set (or otherwise considered likely to be games), while a selection of games that do not have these terms may be selected in a negative training set (or otherwise considered not likely to be games). The application data analyzed to determine a target gaminess values may include the title, publisher comments, tags provided by a data source 114 (such as the an application developer 114A) or at the software application marketplace 106, comments relating to an application, and any information stored in an application record 270. The negative training set may be selected at random from the applications that do not match any terms.

In a further configuration, target gaminess values are determined based on identifications from an application publisher or software application marketplace 106. For example, an application may be designated as a game, or may be associated with a game-related tag or label. A game-related tag or label may be a label associated with the application that refers to a term associated with game applications, such as “shooter” “strategy” or “rpg.” The identification of labels may be based on a dictionary, as described above, or may be based on an identification by a human operator of the search system 100, or by another method. These applications may be treated as members of the positive training set or otherwise assigned a target training value indicating a high likelihood of being a game application.

Further techniques and other methods may be used to select applications for the training set and associate target gaminess values with the selected applications. Thus, the selection of the training set may be performed in a supervised or unsupervised manner. In one embodiment, some applications for the training set are selected by an operator in a supervised manner, while additional applications are selected in an unsupervised manner.

Using the selected training set and target gaminess values, training module 230 trains the gaminess computer model 250. As described above, the gaminess computer model 250 may be any suitable computer model for receiving application information and outputting a gaminess value. The application data used to train the gaminess computer model 250 may be any suitable application data, such as the application name 300, application attributes 304, and other application scoring features 306. Thus, the training data may include application attributes 304 such as reviews, descriptions, user comments, number of downloads, average ratings, and so forth. After training, the gaminess computer model 250 is configured to receive such application data and generate a gaminess value based on the application data. As described above, the gaminess computer model 250 outputs a gaminess value that describes the likelihood that the subject application is a game.

Gaminess module 240 applies the gaminess computer model 250 to generate the gaminess value for at application. In one embodiment, the gaminess module 240 receives a set of data for a particular application, and assigns a gaminess value to the application based on the data by applying the gaminess computer model 250. For example, the gaminess module 240 may receive any suitable data for an application, such as a description of the application, the name of the application, crowd sourced data about the application, the number of total downloads of the application, the overall popularity of application, the number of downloads/popularity of the application as a function of time, the number of downloads/popularity of the application by geographical region, the number of downloads/popularity of the application by application version (e.g., numbers of downloads for the APPLE iOS platform, the GOOGLE ANDROID platform, the MICROSOFT WINDOWS platform, etc.), demographic data for users that downloaded or rated the application, data for sources from which application was download, etc. Based on the inputs and on the gaminess scoring model 240, the gaminess classifier determines a gaminess value for the application, which is then assigned to the application.

FIG. 4 shop example of a flow for generating a gaminess value 308 using a gaminess computer model 250. Initially, application data 260 is collected by the data intake module 210 and stored. The training selection module 220 selects applications and determines a training set 400 of applications and associates a training gaminess value with the applications in the training set 400. As described above, the selection of a training set 400 may be performed via a supervised process (i.e., selection by an operator or operators) or by an unsupervised process (i.e., by the training selection module 220 without operator entry) or by a combination of these. Using the training set 400, the training module 230 generates the gaminess computer model 250 as described above. This gaminess computer model is applied by the gaminess module 240 to an individual application record 270 to generate a gaminess value 308 for that application record 270.

Returning to FIG. 2, after determining the gaminess value for various applications, the application search system directly or indirectly uses the gaminess value to compensate for game bias in search results for applications. In particular, responsive to receiving a search query received from a user device 102 or some other entity, the search system 100 identifies a set of applications that are determined to be at least partially aligned with an intent of the search query. This search functionality is implemented by search module 200.

The search module 200 may use the application scoring features to generate results scores for search results. Accordingly, in one embodiment the search module 200 generates result scores based on gaminess values as an application scoring feature. The search module 200 may also generate result scores based on other scoring features, such as query scoring features, application-query scoring features, and application scoring features derived from data other than market-adjusted statistics. The operation of search module 200 is further described with reference to FIG. 5.

FIG. 5 shows an example search module 200 which may be included in the search system 100. The application search module 200 includes a query analysis module 510, an application set generation module 520 (hereinafter “set generation module 520”), and an application set processing module 530 (hereinafter “set processing module 530”). The query analysis module 510 analyzes a received search query 500. The set generation module 520 identifies a set of applications (e.g., application records) based on the received search query 500. The identified set of applications is referred to herein as a “consideration set.” The set processing module 530 processes (e.g., scores) the consideration set to generate a set of search results 540 that may include a list of applications along with corresponding result scores used to rank the applications in the list.

The search query 500 may be a search query entered by a user on a user device 102. The search query 500 includes text, numbers, and/or symbols (e.g., punctuation) entered into the user device 102 by the user. For example, the user may have entered the search query 500 into a search field (e.g., a search box) of an application running on the user device 102 using a touch screen keypad, a mechanical keypad, and/or via speech recognition. The search results 540 generated by the application search module 110 may be transmitted back to the user device 102 that provided the search query 500.

Although the search system 100 (e.g., the query analysis module 510) is illustrated and described herein as receiving a search query 500 that includes text, the search system 100 (e.g., the query analysis module 510) may receive additional data along with the search query 500. The search query 500 and the additional data along with the search query 500 may be referred to as a query wrapper. In some examples, the query wrapper may include contextual information associated with the search query 500, such as platform constraint information (e.g., operating system version, device type, browser version), geo-location preferences, partner specific information (e.g., which services are being used to access the search system 100), and other information. A user device 102 may generate and transmit the additional data included in a query wrapper at the time the user device 102 transmits the search query 500.

The query analysis module 510 receives the search query 500 from a user device 102. The query analysis module 510 may perform various analysis operations on the received search query 500. For example, analysis operations performed by the query analysis module 510 may include, but are not limited to, tokenization of the query, filtering of the query, stemming, synonymization, and stop-word removal. In one configuration of the query analysis module 510, the search query 500 is also analyzed to identify an express game intent. The express game intent may be identified from the received search query 500 based on terms of the search query, such as “game” or may be identified in the query wrapper. The express game intent represents whether the user has specifically searched for a game.

The set generation module 520 identifies a set of applications (i.e., the consideration set) based on the search query 500. In some examples, the set generation module 520 may identify the set of applications by identifying application records based on matches between terms of the search query 500 and terms in the application records. For example, the set generation module 520 may identify a set of applications in the application data store 108 base on matches between tokens generated by the query analysis module 510 and words included in the application records. The consideration set of applications may be a list of application records in some examples. For example, the consideration set may be a list of application IDs and/or a list of application names. In one embodiment, the set generation module 520 uses the gaminess value of an application to exclude or include that application in the consideration set. This inclusion or exclusion may be based, for example, on the express game intent. Thus, in one embodiment, when the user expresses intent to search for a game, the set generation module 520 excludes applications that are below a threshold gaminess value (e.g., 0.4). Similarly, when the user expresses intent not to search for a game, the game generation module 520 excludes applications that are above a threshold gaminess value (e.g., 0.6).

The set processing module 530 performs a variety of different processing operations on the consideration set to generate a set of search results 540 that includes a list of applications. In some implementations, the set processing module 530 may generate a result score for each of the applications included in the consideration set in order to generate the set of search results 540. In these implementations, the set of search results 540 may include a list of applications (e.g., application IDs and/or application names), each of which is associated with a corresponding result score. In some examples, the search results 540 may include all of the applications from the consideration set. In other examples, the search results 540 may include a subset of the consideration set. For example, the subset may be those applications having the largest result scores.

The information conveyed by the search results 540 may depend on how the result scores are calculated by the se processing module 530. For example, the result scores may indicate the relevance of application to the search query, the popularity of an application in the marketplace, the quality of an application, or other properties of the application, depending on what parameters the set processing module 530 uses to score the applications.

The set processing module 530 may generate result scores for applications in a variety of different ways. In general, the set processing module 530 may generate a result score for an application based on one or more scoring features. The scoring features may be associated with the application and/or the search query 500.

An application scoring feature may include any data associated with an application. For example, application scoring features may include any of the application attributes included in the application record or any additional parameters related to the application, such as data indicating the popularity of an application (e.g., number of downloads) and the ratings (e.g., number of stars) associated with an application. As described above, one or more application scoring features may be based on the gaminess value 308 off the application. The gaminess value 308 is included as a scoring feature whether or not the query includes or as analyzed to identify a game intent. Thus, in this configuration the scoring features of an application include the gaminess value 308 as a factor for determining relevance of the search results (the result score), even when the search query 500 may not relate to games, or is not known if it relates to games.

A query scoring feature may include any data associated with the search query 500. For example, query scoring features may include, but are not limited to, a number of words in the query, the popularity of the query, and the expected frequency of the words in the query. An application-query scoring feature may include any data which may be generated based on data associated with both the application and the search query 500 (e.g., the query that resulted in identification of the application record by the set generation module 520). For example, application-query scoring features may include, but are not limited to, parameters that indicate how well the terms of the query match the terms of the identified application record. The set processing nodule 530 may generate the query scoring features and/or the application-query scoring features. The set processing module 530 may generate a result score for an application based on at least one of the application scoring features, the query scoring features, and the application-query scoring features.

The set processing module 530 may determine a result score based on one or more of the scoring features listed herein and/or additional scoring features not explicitly listed. In some examples, the set processing module 530 may include a function that receives one or more of the scoring features as input. The function may also be based on scoring features that incorporate a number of downloads of the application, term frequency-inverse document frequency (TFIDF) scoring, text matches between search query terms and application title, and the number of words in the description of the application, for example. Although an example function may include the above listed features, other functions incorporating different features may be used by the set processing module 530.

In some examples, the set-processing module 530 may include one or more machine learned models (e.g., a supervised learning model) configured to receive one or more scoring features, such as application scoring features derived a gaminess value. The one or more machine learned models may generate result scores based on at least one of the application scoring features, the query scoring features, and the application-query scoring features. For example, the set processing module 530 may pair the search query 500 with each application and calculate a vector of features for each (query, application) pair. The vector of features may include application scoring features, query scoring features, and application-query scoring features. The set processing module 530 may then input the vector of features into a machine-learned regression model to calculate a result score that may be used to rank the application in the search results 540 for the search query 500. In some examples, the set processing module 530 may input the vector of features along with a corresponding set of human curated scores into a machine-learned regression model to calculate a result score.

In some examples, the machine-learned regression model may include a set of decision trees (e.g., gradient boosted decision trees). In another example, the machine-learned regression model may include a logistic probability formula. In some examples, the machine learned task can be framed as a semi-supervised learning task, where a minority of the training data is labeled with human curated scores and the rest are used without human labels.

As described above, in one configuration the feature vector for each application used by the relevancy classifier includes the previously determined gaminess value for the application. Thus, in processing the feature vector and calculating a result score, the relevancy classifier considers the gaminess of the application. In one implementation, the game bias is accounted for without receiving a specific intent in the search query indicating a desire to identify either games or non-games. Rather, game bias is automatically reduced or otherwise accounted for as a result of the previous training used to generate the machine-learned relevancy model, where the sample input data used for training included gaminess values. In other implementations, game bias is accounted for (or not accounted for) responsive to receiving (or not receiving) a specific intent in the search query indicating a desire for the identification of either games or non-games.

In one embodiment, the result scores are adjusted or post-processed after the result score is generated from the machine-learned result score model. In this embodiment, the result scores may be adjusted based on the gaminess value of the applications. For example, the gaminess value may be used to account for the game bias relative to other applications, by reducing the result score of applications with a high gaminess value, and increasing the result score of applications with a low gaminess value. This adjustment may be applied in an embodiment where the gaminess value is not used as a scoring feature, or may be applied in conjunction to the gaminess value used as a scoring feature. In this way, the result scores may be modified to compensate for game bias.

The results scores may be used in a variety of different ways. In some examples, the result scores may be used to rank the applications in a list of results that is presented on a user device 102. In these examples, a larger result score may indicate that the application is more relevant to a user than an application having a smaller result score. In examples where the search results 540 are displayed as a list on a user device 102, the applications associated with larger result scores may be listed nearer to the top of the results list (e.g., near to the top of the screen). In these examples, applications having lower result scores may be located farther down the list (e.g., off screen) and may be accessed by a user scrolling down the screen of the user device 102.

In some implementations, the set of search results 540 may be transmitted to a user device 102 that generated the search query 500 upon which the search results 540 are based. The search results 540 may be formatted on a user device 102 as a list of applications matching the search query 500. The search results 540 may include any suitable information corresponding to the various applications. For example, the search results 540 provided by the search system 100 to a user device 102 may be formatted as a list of applications, including, for example, a name of the application, an image associated with the application (e.g., a logo, a screenshot, and/or a video), a link to download the application, a description and rating of the application, and/or other information.

In a configuration, the search results 540 transmitted to the user device 102 may also separate game and non-game applications into distinct lists for presentation on the user device 102. To separate the search results, the application set processing module 530 may use the gaminess value to determine whether resulting game can be categorized as a game or as not a game. In addition to providing two specific lists, the application set processing module 530 may use the gaminess values to otherwise organize or cluster the search results 540. In this way, the application's gaminess value may be used in ways to present the applications in addition to sorting the applications by result score.

Although the search system 100 may transmit the search results 540 to a user device 102 in some implementations, in other implementations, the search system 100 may use the search results 540 in a different manner. For example, the search system 100 may use the search results 540 as a basis for generating advertisements for the user. The search system 100 may select which of the search results 540 to transmit to a user device 102 in some examples. For example, the search system 100 may only transmit the highest ranked search result to a user device 102 in some examples.

FIG. 6 shows an example method 600 for performing a search based on a received search query. The method 600 is performed in one embodiment by the application search module 200 of FIG. 5. In block 602, the query analysis module 510 receives a search query 500 that was generated by a user device 102. In block 604, the query analysis module 510 analyzes the search query 500. In block 606, the set generation module 520 identifies a consideration set of applications (e.g., a set of application records) based on the search query 500 (e.g., based on output from the query analysis module 510).

In block 608, the set processing module 530 generates result scores for each application in the consideration set based on scoring features, such as query scoring features, application-query scoring features, and application scoring features. One or more of the application scoring features may be derived from the gaminess value of the application as described above. In block 610, the set processing module 530 generates a set of search results 540. The search results 540 may include a list of applications and associated result scores. The search system 100 may then transmit the search results 540 to a user device 102 in some examples.

### Impact of Gaminess in Improving Search Relevance

As a specific example, Tables 1 and 2 together illustrate the importance of the gaminess feature in the relevance model. Table 1 shows that the gaminess feature is significant with regards to predicting overall relevance, even when there is no corresponding query-feature indicating query-intent (i.e. whether the user is searching for games). Without the gaminess feature, the Mean Squared Error (MSE) on the Cross Validation is substantially higher. As used herein, a scoring feature or attribute is an item of data describing a particular aspect or characteristic of an application (e.g., a functionality of an application), a property of a search query, a particular relationship between an application and a search query, etc.

Referring to table 1, it includes data for an application search system that considers gaminess to minimize game bias. As shown, the MSE value for search results generated by such an application search system is 0.0287621. Table 1 also indicates that gaminess is the fifth most important or useful feature used for scoring. In contrast, table 2 includes data for an application search system that does not consider gaminess. As shown, the MSE value for search results generated by such an application search system is 0.0304064, which indicates that the search results generated by the application search system not considering gaminess has a higher predicted error rate. Hence, as illustrated by tables 1 and 2, consideration of gaminess as a scoring feature for query relevance improves overall accuracy of a machine-learned relevance model.

TABLE I
Mean Squared Error (MSE) from Cross Validation = 0.0287621

| | ABS | REL |
|---|---|---|
| FEATURE A | 100.0000000 | 100.00 |
| FEATURE B | 70.9587580 | 70.96 |
| FEATURE C | 60.7860939 | 60.79 |
| FEATURE D | 44.5361159 | 44.54 |
| GAMINESS | 39.7530254 | 39.75 |
| FEATURE F | 38.5533654 | 38.55 |
| FEATURE G | 31.0865027 | 31.09 |
| FEATURE H | 29.5866996 | 29.59 |
| FEATURE I | 23.1471386 | 23.15 |

TABLE 2
Mean Squared Error (MSE) from Cross Validation = 0.0304064

| | ABS | REL |
|---|---|---|
| FEATURE A | 100.0000000 | 100.00 |
| FEATURE B | 75.6453598 | 75.65 |
| FEATURE C | 61.4104023 | 61.41 |
| FEATURE F | 39.3342878 | 39.33 |
| FEATURE D | 38.1961124 | 38.20 |
| FEATURE G | 31.6640390 | 31.66 |
| FEATURE I | 22.6661296 | 22.67 |
| FEATURE J | 22.6557200 | 22.66 |
| FEATURE K | 22.4073503 | 22.41 |
| FEATURE L | 22.3191239 | 22.32 |
| FEATURE M | 21.7244993 | 21.72 |
| FEATURE N | 18.6939473 | 18.69 |
| FEATURE O | 18.4272254 | 18.43 |
| FEATURE P | 18.3582398 | 18.36 |

### Computing Machine Architecture

The disclosed software structures and processes are configured for operation on a machine, e.g., a computing system. FIG. 7 is a block diagram illustrating components of an example machine able to read instructions from a machine-readable medium and execute them in a processor (or controller). The machine can be configured to execute the system and processes described above. Specifically, FIG. 7 shows a diagrammatic representation of a machine in the example form of a computer system 700 within which instructions 724 (e.g., software for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine for this configuration may be a mobile computing devices such as a tablet computer, an ultrabook (or netbook) computer, a personal digital assistant (PDA), a cellular telephone, a smartphone, a web appliance, or like machine capable of executing instructions 724 (sequential or otherwise) that specify actions to be taken by that machine. Further, while only a single machine is illustrated, the term “machine” shall also be taken to include any collection of machines that individually or jointly execute instructions 724 to perform any one or more of the methodologies discussed herein.

The example computer system 700 includes one or more processors 702 (e.g., a central processing unit (CPU) and may also include a graphics processing unit (GPU), a digital signal processor (DSP), one or more application specific integrated circuits (ASICs), one or more radio-frequency integrated circuits (or chipset) (RFICs), a wireless fidelity (WiFi) chipset, a global positioning system (GPS) chipset, an accelerometer (one, two, or three-dimensional), or any combination of these). The computer system 700 also includes a main memory 704 and a static memory 706. The components of the computing system are configured to communicate with each other via a bus 708. The computer system 700 may further include graphics display unit 710 (e.g., a plasma display panel (PDP), a liquid crystal display (LCD)) which may be configured for capacitive or inductive touch sensitivity to allow for direct interaction with software user interfaces through the display 710. The computer system 700 may also include alphanumeric input device 712 (e.g., a keyboard), a cursor control device 714 (e.g., a mouse, a trackball, a joystick, a motion sensor, or other pointing instrument), a storage unit 716, a signal generation device 718 (e.g., a speaker), and a network interface device 720, which also are configured to communicate via the bus 708.

The storage unit 716 includes a machine-readable medium 722 on which is stored instructions 724 (e.g., software) embodying any one or more of the methodologies or functions described herein. The instructions 724 (e.g., software) may also reside, completely or at least partially, within the main memory 704 or within the processor 702 (e.g., within a processor's cache memory) during execution thereof by the computer system 700, the main memory 704 and the processor 702 also constituting machine-readable media. The instructions 724 (e.g., software) may be transmitted or received over a network 726 via the network interface device 720.

While machine-readable medium 722 is shown in an example embodiment to be a single medium, the term “machine-readable medium” should be taken to include a single medium or multiple media (e.g., a centralized or distributed database, or associated caches and servers) able to store instructions (e.g., instructions 724). The term “machine-readable medium” shall also be taken to include any medium that is capable of storing instructions (e.g., instructions 724) for execution by the machine and that cause the machine to perform any one or more of the methodologies disclosed herein. The term “machine-readable medium” includes, but not be limited to, data repositories in the form of solid-state memories, optical media, and magnetic media.

### Additional Considerations

The embodiments described herein beneficially allow application search systems to provide higher quality search results. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms, for example, as illustrated in FIG. 1A. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA), an application-specific integrated circuit (ASIC), system on a chip (SoC), chipset) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors, that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for performing application search through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer program product for performing application search, the computer program product comprising a non-transitory computer-readable storage medium storing instructions that when executed cause at least one processor to perform steps comprising:
receiving data from one or more data sources for one or more applications;
determining one or more gaminess values for the one or more applications based at least in part on the received data, wherein a gaminess value indicates the likelihood that an application is a game;
receiving a search query including one or more search terms from a user device;
identifying a consideration set of applications based on the search query from the one or more applications;
generating a result score for each application in the identified set based at least in part on the gaminess value for the application in the identified set;
ranking the identified set of applications based on the relevancy score; and
providing a listing of the ranked set of applications to the user device.

2. The computer program product of claim 1, wherein a gaminess value for an application is a value selected from at least three different gaminess values.

3. The computer program product of claim 1, wherein the provided ranked set of applications includes at least one application that is a game and at least one other application that is not a game.

4. The computer program product of claim 1, wherein applications are excluded from the consideration set based on the gaminess value of the applications.

5. The computer program product of claim 1, wherein the result score is generated based on a set of scoring factors applied by a computer model, wherein the gaminess value is a scoring factor.

6. The computer program product of claim 1, wherein the result score for the application is generated based on a set of scoring factors applied by a computer model, wherein the gaminess value modifies the score result of the computer model.

7. The computer program product of claim 6, wherein a gaminess value above a threshold reduces or boosts the score result generated by the computer model.

8. The computer program product of claim 6, wherein a gaminess value below a threshold reduces or boosts the score result generated by the computer model.

9. The computer program product of claim 1, wherein the gaminess values for the one or more applications is determined based on a trained gaminess computer model.

10. The computer program product of claim 9, wherein the trained gaminess computer model is trained using a supervised training set.

11. A computer-implemented method of generating search results for an application search query, comprising:
accessing, by a processor, an application data store including application records, each application record associated with an application and including a gaminess value indicating the likelihood that the application associated with the application record is a game;
receiving a search query including one or more search terms from a user device;
generating, by the processor, a result score for a plurality of applications based at least in part on the gaminess value associated with the applications in the associated application record.

12. The computer-implemented method of claim 11, further comprising training a computer model configured to receive scoring features describing an application and output a result score; wherein the scoring features including a gaminess value; and further wherein generating the result score comprises applying the computer model.

13. The computer-implemented method of claim 11, further comprising training a gaminess computer model to generate a gaminess value, using a training set of application data and target gaminess values, and further generating the gaminess value for an application record by applying the gaminess computer model.

14. The computer-implemented method of claim 13, wherein the target gaminess values are selected by a human operator.

15. The computer-implemented method of claim 13, wherein the target gaminess values are selected based on an average of gaminess selects by a plurality of human operators.

16. The computer-implemented method of claim 13, wherein the target gaminess values are selected based on a dictionary of terms.

17. The computer-implemented method of claim 13, wherein the target gaminess values are determined from a tag or label of the application at a data source or an application marketplace.

18. A computer-implemented method of ordering search results for an application search query, comprising:
accessing, by a processor, an application data store including application records, each application record associated with an application and including a gaminess value indicating the likelihood that the application associated with the application record is a game;
receiving a search query including one or more search terms from a suer device;
generating, by the processor, one or more ranking features for a plurality of applications based at least in part on the gaminess value associated with the applications in the associated application record; and
organizing the consideration set results based on the ranking features.

19. The computer-implemented method of claim 18, wherein organizing the consideration set results comprises clustering the consideration set results based on the gaminess values associated with the applications in the consideration set.

20. The computer-implemented method of claim 18, wherein organizing the consideration set results comprises ranking the consideration set results based on the gaminess values associated with the applications in the consideration set.
